(19) United States
(12) Patent Application Publication
(10) Pub. No.: US 2005/0012311 A1
(43) Pub. Date: Jan. 20, 2005

(54) Assembly with a steering wheel and a gas bag module

(75) Inventors: Michael Schneider, Sulzbach (DE); Matthias Helmstetter, Aschaffenburg (DE); Toralf Muller, Machern (DE)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: TRW Automotive Safety Systems GmbH

(21) Appl. No.: 10/841,017

(22) Filed: May 7, 2004

(30) Foreign Application Priority Data
May 7, 2003 (DE) 203 07 096.8

(51) Int. Cl. B60R 21/16

(52) U.S. Cl. 280/731

(57) ABSTRACT

An assembly comprises a steering wheel and a gas bag module held in a hub region of the steering wheel, the gas bag module being movable in an axial direction of the steering wheel for actuating a horn. The assembly further comprises at least one restoring element having at least one elastic section. The elastic section exerts onto the gas bag module a restoring force acting against an actuating force for the horn. The elastic section extends between a module housing and a fastening for the restoring element provided in the hub region of the steering wheel. The elastic section is securely and non-displaceably connected at one end with the module housing and at another end with the fastening in the hub region. The elastic section has between the ends a contact section which forms an electric horn contact.

### FIELD OF THE INVENTION

The invention relates to an assembly with a steering wheel and a gas bag module.

### BACKGROUND OF THE INVENTION

In gas bag modules held in a hub region of a steering wheel, movable in axial direction of the steering wheel for actuation of a horn against a restoring force (also designated as “floating horn” modules), the endeavour is to keep the number of components small, as far as possible, whilst at the same time a guidance of the gas bag module, free from play, in its direction of movement has to be ensured.

### BRIEF SUMMARY OF THE INVENTION

It is an object of the invention to provide a simple assembly which fulfils these requirements.

For this, an assembly comprises a steering wheel and a gas bag module held in a hub region of the steering wheel, the gas bag module being movable in an axial direction of the steering wheel for actuating a horn. The assembly further comprises at least one restoring element having at least one elastic section. The elastic section exerts onto the gas bag module a restoring force acting against an actuating force for the horn. The elastic section extends between a module housing and a fastening for the restoring element provided in the hub region of the steering wheel. The elastic section is securely and non-displaceably connected at one end with the module housing and at another end with the fastening in the hub region. The elastic section has between the ends a contact section which forms an electric horn contact.

As one of the horn contacts is therefore already definitely given, in each case only a horn contact complementary to this horn contact has to be placed in the steering wheel or on the gas bag module, which keeps the expenditure for production and installation low. This also results in a high degree of freedom as regards design, because the arrangement of the contact section on the elastic section can be selected in accordance with the respective requirements, and the elastic section or the contact section itself can have a relatively large extent. The secure connection of the elastic section both with the gas bag module and also with the steering wheel brings about, in addition, a secure guidance, free from play, of the gas bag module on actuation of the horn.

As a whole, several elastic sections, several contact sections and corresponding complementary horn contacts can be provided. The horn contact complementary to the contact section is preferably arranged on the gas bag module, but can of course also be placed on the steering wheel.

The possibility presents itself of constructing either the entire restoring element or at least the entire elastic section so as to be electrically conductive, so as not to have to contact the contact section separately.

The elastic section extends in the installed state of the gas bag module in the steering wheel preferably obliquely between the gas bag module and the hub region of the steering wheel. Through this arrangement, a restoring force is automatically produced for example with the use of an elastic wire as restoring element with a deflection of the gas bag module. Spiral springs can thus be dispensed with.

In a preferred embodiment of the invention, the elastic section, in a first deflected position in which a first restoring force is generated, is in contact with a complementary horn contact.

The installation of the gas bag module on the steering wheel can be simplified by provision being made that the elastic section is movable into a second deflected position in which a second restoring force is generated which is greater than the first restoring force. Usually, in the second deflected position, the elastic section will be bent more strongly than in the first deflected position. This arrangement allows a detent connection between a fastening element of the gas bag module and the steering wheel to be closed in the second deflected position and such ensures a secure engagement of fastening elements, which fix the gas bag module to the steering wheel, more precisely e.g. to its skeleton. The fastening elements are preferably separate components with respect to the restoring element. Through the strong restoring force in the second deflected position, the gas bag module is moved after installation on the steering wheel from the installation position (corresponding to the second deflected position) into its normal position.

Independently of the fastening of the gas bag module on the steering wheel, the connection between the elastic section and the gas bag module and/or the steering wheel can also be a detent connection.

Preferably, for this, the fastening of the restoring element in the hub region of the steering wheel is formed by a foamed section of the steering wheel, with which one end of the elastic section can engage. In this way, both the detent connection for fastening the gas bag module on the steering wheel and also the detent connection for the secure connection of the elastic section of the restoring element with the steering wheel can be produced by simple insertion of the gas bag module into the hub region of the steering wheel. The detent connection between the elastic section and the foamed section does not have to be able to withstand such high forces here as the detent connection for fastening the gas bag module.

The restoring element or its elastic section can also be engaged on the module housing. Preferably, however, the end of the elastic section fixed to the module housing is embedded into the module housing, for example by casting around or injecting around. This solution presents itself particularly when the module housing consists of plastic.

It is also possible to firstly connect the restoring element securely with the steering wheel and then by means of a detent connection with the gas bag module. For this, for example, one end of the restoring element could be embedded into a plastic or foam part in the hub region of the steering wheel.

Preferably the elastic section or sections extend substantially radially. Thus, a uniform restoring force is produced and a guidance, free of play, without tilting the gas bag module. The restoring element can be, for example, a single-piece, bent wire.

In order to avoid short circuits, the restoring element, outside the contact section and of course a corresponding contacting to a horn electric circuit, is preferably insulated with respect to the gas bag module or the steering wheel. The use of a module housing of plastic simplifies the insulation here.

According to the invention, the restoring element can undertake three functions. Firstly, it generates the restoring force with an actuation of the horn, secondly it can be able to fulfil a function as guide for the gas bag module with the axial movement of the gas bag module and thirdly, it may form one half of the horn contacts.

### BRIEF DESCRIPTION OF THE DRAWINGS

FIG. 1 shows a diagrammatic perspective partial view of a gas bag module of an assembly according to the invention, viewed from its underside;

FIG. 2 shows a diagrammatic perspective partial view of a module housing for a gas bag module of an assembly according to the invention, in accordance with a variant to the housing shown in FIG. 1;

FIG. 3 shows a view, partially in section, of an assembly according to the invention in a state in which the gas bag module according to FIG. 1 or 2 is connected with the steering wheel and the horn is not actuated;

FIG. 4 shows the assembly of FIG. 3 in a state in which the gas bag module is connected with the steering wheel and the horn is actuated; and

FIG. 5 shows the assembly of FIG. 3, where the gas bag module is in the state of being connected with the steering wheel.

### DETAILED DESCRIPTION OF A PREFERRED EMBODIMENT

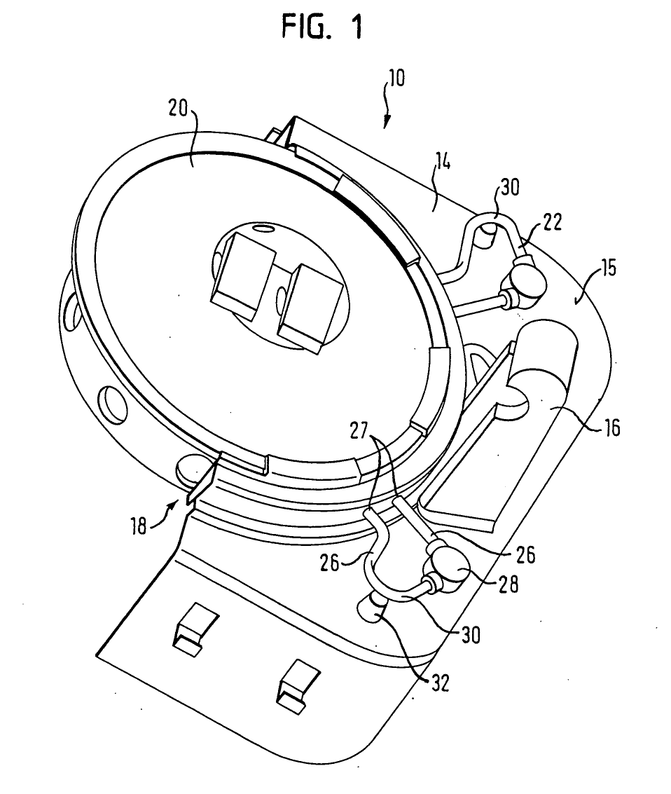

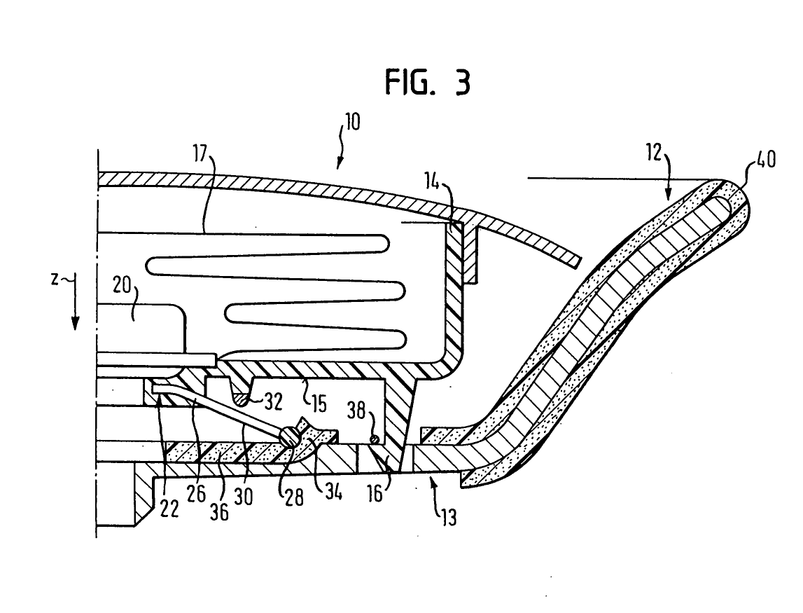

FIG. 1 shows the underside of a gas bag module 10, as can be inserted for example into a steering wheel 12 shown in FIGS. 3 to 5.

A module housing 14, which is formed here by a generator carrier consisting of plastic, has on its underside 15 detent hooks 16 for fastening the gas bag module to the steering wheel 12. In addition, a mounting 18 is formed for a gas generator 20, in which the gas generator 20 is fixed in a known manner. Inside the module housing 14, a folded gas bag 17 is held (see FIG. 3).

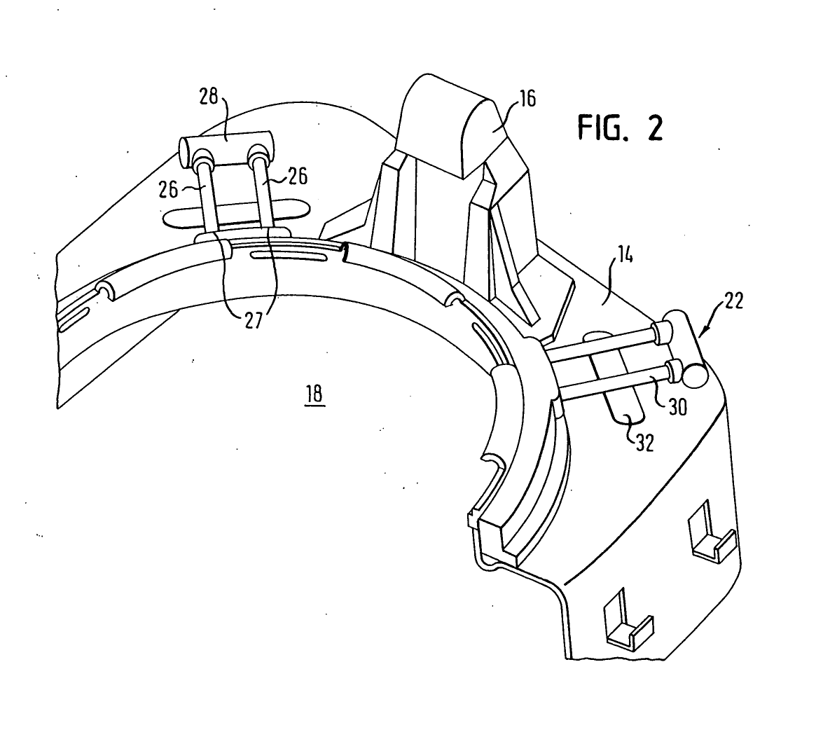

On the underside 15 of the module housing 14, here on the mounting 18 surrounding the gas generator 20 peripherally, several elastic restoring elements 22 are arranged. Each restoring element 22 has two elastic sections 26, which are respectively connected at a first end 27 securely and undisplaceably with the module housing 14. In the example shown in FIGS. 1 and 2, the restoring elements 22 can be connected with the module housing 14 by means of detent connections, whereas in the gas bag module 10 shown in FIGS. 3 to 5 they are embedded into the module housing 14 actually by injection molding or casting. The restoring elements could, however, also be fixedly connected with the module housing 14 in another suitable manner, e.g. by means of a deformation process.

The restoring elements 22 consist substantially of a single-piece elastic wire bent into a corresponding shape. The elastic sections 26 of the restoring elements 22 extend substantially in radial direction, as long as the gas bag module 10 is not connected with the steering wheel 12. In each case two of the elastic sections 26 are connected by a punctiform fastening section 28, which forms a second end of each elastic section. If the gas bag module 10 is inserted into the steering wheel 12, the elastic sections 26 run obliquely from the underside 15 of the module housing 14 to the hub region 13 of the steering wheel 12.

In the example shown in FIG. 1, in each case one of the elastic sections 26 has a contact section 30 bent in a curved shape, which forms a horn contact.

In FIG. 2 a variant of the restoring element 22 is illustrated, in which the elastic sections 26 run parallel to each other radially outwards and the fastening section 28 extends perpendicularly to the elastic sections 26. Here, a contact section 30 is constructed as horn contact on each of the elastic sections 26.

In the embodiments shown, in each case several contact sections 30 are provided. Each of the contact sections 30 can come in contact with complementary horn contacts 32, which are constructed here as separate projections on the underside 15 of the module housing 14 or are embedded into the module housing 14. In the variant shown in FIG. 1, in each case only one contact section 30 is associated with a complementary horn contact 32, whereas in the variant shown in FIG. 2 there are two contact sections 30 in each case.

The horn contacts 30, 32 are connected with a horn electric circuit (not shown) in a manner known to the specialist in the art. The horn contacts 30, 32 and the horn electric circuit are designed so that with a contact of a contact section 30 with a horn contact 32, the horn sounds.

The fastening sections 28 are insulated with respect to the free sections 26, which in whole or in part (at least, however, in the region of the contact sections 30) are not insulated electrically. The restoring elements 22 are electrically insulated with respect to the module housing 14. With a module housing 14 consisting of plastic, no further precautions are required for this; with a metallic module housing, precautions for electrical insulation, known to the specialist in the art, are to be met. The insulation of the restoring elements 22 can be realized for example by an injection molded plastic encasement in all regions apart from the contact sections 30.

FIGS. 3 to 5 show an assembly in which the gas bag module is inserted into a hub region 13 of a steering wheel 12.

The gas bag module 10 is securely connected with the steering wheel 12 by means of the detent hooks 16 and arresting means 38, fixed to the steering wheel, arranged in the hub region 13 of the steering wheel 12. The arresting means 38 consist here of a component (e.g. a wire) securely held in the steering wheel 12, but displaceable by a certain amount, into which the detent hooks 16 engage. This connection is designed so that a movement of the gas bag module 10 in vertical direction z (i.e. in the direction of the rotation axis of the steering wheel) inside the steering wheel 12 is made possible, without the detent connection 16, 38 being released.

The fastening sections 28 of the restoring elements 22 are connected with pocket-shaped fastenings 34, which are constructed through foamed sections 36 in the steering wheel interior and form mountings for the fastening sections 28. The elastic sections 26 of the restoring elements 22 extend obliquely between the gas bag module 10 and the hub region 13 of the steering wheel 12.

The elastic sections 26 are designed so that the force which is opposed to a movement of the gas bag module 10 in axial direction (z-direction), on the one hand is so great that the gas bag module 10 is not set in motion owing to vehicle vibrations in the steering wheel 12, but on the other hand is so low that the driver can press down the gas bag module 10 for actuation of the horn without a great expenditure of force.

In the normal position illustrated in FIG. 3, the gas bag module 10 is securely connected with the steering wheel 12, and the horn is not actuated. The elastic sections 26 are situated in a non-deflected position, and no contact section 30 touches a complementary horn contact 32. The elastic sections 26, however, are pre-stressed to a certain degree, which eliminates a spontaneous movement of the gas bag module in axial direction z, for example owing to vehicle movements.

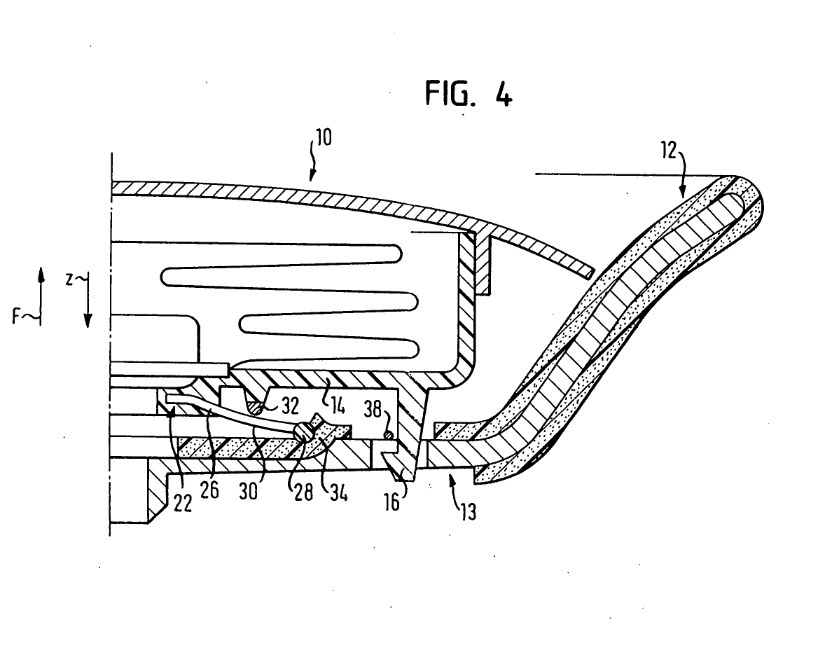

FIG. 4 shows the assembly of FIG. 3 with actuated horn. The gas bag module 10 was shifted as a whole for a distance in axial direction z. This movement leads to the elastic sections 26 of the restoring element 22 being deflected into a first position and having assumed a first curvature. At the same time, the distance between the contact sections 30 and the complementary horn contacts 32 has reduced to such an extent that the contact sections 30 and the complementary horn contacts 32 come into contact with each other, so that the horn electric circuit is closed. The gas bag module 10 is still connected with the steering wheel 12 by means of the detent connection 16, 38 and the restoring elements 22.

During the movement of the gas bag module 10, the elastic sections 26 remain securely and non-displaceably connected both with the module housing 14 and also with the foamed section 26 of the steering wheel 12. In this state, the restoring element 22 exerts a restoring force F onto the gas bag module 10, via its elastic sections 26 which are bent into a first deflected position, which force endeavours to return the gas bag module 10 into its normal position (see FIG. 3).

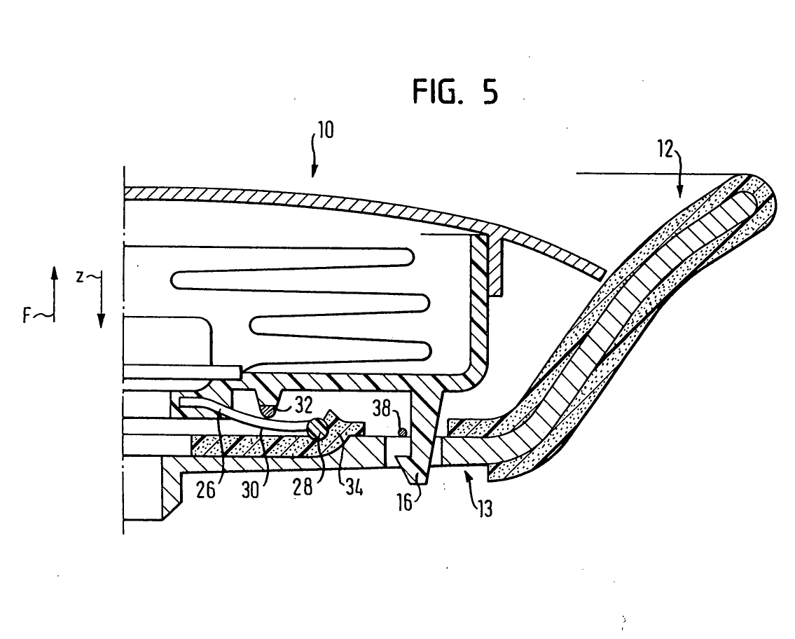

The position of the gas bag module 10 in the steering wheel 12, shown in FIG. 5, is only assumed with the fastening of the gas bag module 10 on the steering wheel 12.

For this, the gas bag module 10 is pushed further into the interior of the steering wheel 12 than is necessary for actuating the horn. The elastic sections 26 of the restoring element 22 are bent here into a second deflected position, in which they are further deflected and more intensively bent than in the first deflected position for actuation of the horn, from which a stronger restoring force results than in the first deflected position. In this second deflected position of the restoring elements 22 the detent hooks 16 can be brought securely in engagement with the arresting means 38 of the steering wheel 12.

On insertion of the gas bag module 10 into the steering wheel 12, also at the same time a detent connection is closed between the fastening elements 28 and the fastening 34 in the steering wheel 12 by simple pushing in. In the embodiment according to FIG. 2, the fastening 34 forms a swivel bearing for the restoring element 22, in which the cylindrical fastening section 28 is inserted into a cylindrical, partially open fastening 34 (see also FIGS. 3 to 5), in which the fastening section 28 can rotate (see FIG. 5).

The main load of the fastening of the gas bag module 10 on the steering wheel 12 in z-direction is borne by the detent connection 16, 38, whereas the detent connection 28, 34 between the restoring element 22 and the foamed section 36 only has to withstand small forces in z-direction. The fixing of the elastic sections 26 on the steering wheel 12 provides for an exact guidance of the movement of the gas bag module 10.

Alternatively, it is also possible to fixedly encase the restoring elements by injection molding or foaming or to provide a detent connection for the restoring elements with the hub region of the steering wheel, and to provide a detent connection with the module housing which is closed when the gas bag module is inserted into the steering wheel.

In the examples shown here, the direction z runs perpendicular to the plane of a steering wheel rim 40, i.e. in axial direction of the steering wheel 12. The invention is, however, also able to be converted for steering wheels in which the direction of movement for actuation of the horn takes place in another direction.

1. An assembly, with a steering wheel (12) and a gas bag module (10) held in a hub region (13) of said steering wheel (12), said gas bag module (10) being movable in an axial direction (z) of said steering wheel (12) for actuating a horn, and
with at least one restoring element (22) having at least one elastic section (26),
said elastic section (26) exerting onto said gas bag module (10) a restoring force acting against an actuating force for said horn,
said elastic section (26) extending between a module housing (14) and a fastening (34) for said restoring element (22) provided in said hub region (13) of said steering wheel (12),
said elastic section (26) being securely and non-displaceably connected at one end (27) with said module housing (14) and at another end (28) with said fastening (34) in said hub region (13), and
said elastic section (26) having between said ends (27, 28) a contact section (30) which forms an electric horn contact.

2. The assembly according to claim 1, wherein said elastic section (26) extends obliquely between said gas bag module (10) and said hub region (13) of said steering wheel (12).

3. The assembly according to claim 1, wherein in a first deflected position, in which a first restoring force is generated, said elastic section (26) is in contact with a complementary horn contact (32).

4. The assembly according to claim 3, wherein said elastic section (26) is movable into a second deflected position, in which a second restoring force is generated, which is greater than said first restoring force.

5. The assembly according to claim 4, wherein in said second deflected position a detent connection (16, 38) can be closed between a fastening element (16) of said gas bag module (10) and said steering wheel (12).

6. The assembly according to claim 1, wherein at least one of said connection between said restoring element (22) and said gas bag module (10) and said fastening (34) of said restoring element (22) in said steering wheel (12) is a detent connection (28, 34).

7. The assembly according to claim 6, wherein said fastening (34) is formed by a foamed section (36) of said steering wheel (12).

8. The assembly according to claim 1, wherein said fastening (34) is constructed as a swivel bearing for said restoring element (22).

9. The assembly according to claim 1, wherein a horn contact (32) complementary to said contact section (30), is arranged on said gas bag module (10).

10. The assembly according to claim 1, wherein said end (27) of said elastic section (26), fixed to said module housing, is embedded into said module housing (14) of said gas bag module (10).

11. The assembly according to claim 1, wherein said elastic section (26) is a wire-shaped body extending substantially radially.
